(19) United States
(12) Patent Application Publication
(10) Pub. No.: US 2026/0258513 A1
(43) Pub. Date: Sep. 3, 2026

(54) SYSTEMATIC CARBON EMISSIONS REDUCTION METHOD FOR WHOLE PROCESS OF PRODUCTION AND CASTING

(71) Applicant: JIQING LOW CARBON TECHNOLOGY (QINHUANGDAO) CO., LTD., Changli, Qinhuangdao, Hebei (CN)

(72) Inventors: Yuzhu YANG, Qinhuangdao (CN); Han DONG, Shanghai (CN); Xionggang LU, Shanghai (CN); Guocheng ZHOU, Qinhuangdao (CN); Yuwen ZHANG, Shanghai (CN); Kai ZHU, Shanghai (CN); Quanli LIU, Qinhuangdao (CN); Jian LI, Qinhuangdao (CN); Wenhe WU, Shanghai (CN); Yuwen YANG, Qinhuangdao (CN)

(73) Assignee: JIQING LOW CARBON TECHNOLOGY (QINHUANGDAO) CO., LTD., Changli, Qinhuangdao, Hebei (CN)

(21) Appl. No.: 19/165,351

(22) PCT Filed: Mar. 22, 2024
(86) PCT No.: PCT/CN2024/083411

§ 371 Date: Sep. 15, 2025

(30) Foreign Application Priority Data
Mar. 28, 2023 (CN) 202310314810.3

(51) Int. Cl. C21B 5/00; B01D 53/14; C21B 5/06; C21C 5/38; C21C 5/52

(52) U.S. Cl. CPC C21B 5/001; B01D 53/1425; B01D 53/1493; C21B 5/06; C21C 5/38; C21C 5/52; B01D 2252/103; B01D 2257/20; B01D 2257/30; C21B 2100/22; C21B 2100/42; C21B 2100/44; C21B 2100/62; C21B 2400/08; C21C 2100/06

(57) ABSTRACT

The present invention discloses a systematic carbon emissions reduction method for whole process of steel production and casting, comprising the steps of: injecting hydrogen into a blast furnace, wherein the hydrogen is sourced from a nuclear-based hydrogen production system, a water electrolysis hydrogen production system, and a coke oven gas-steam reforming hydrogen production system; wherein electrical energy consumed by the water electrolysis hydrogen production system is sourced from gas-fired power generation, steam residual pressure power generation, solar power generation, wind power generation, and nuclear power generation; wherein combustible gases used for the gas-fired power generation are coke oven gas, blast furnace gas, and converter gas; wherein steam for the steam residual pressure power generation is sourced from a sintering waste heat boiler; wherein steam for the coke oven gas-steam reforming hydrogen production is low-pressure steam exhausted from the residual pressure power generation; producing end products comprising cast steel sections and casting materials including high-carbon ductile cast iron profiles with a carbon content of 2-4% and a silicon content of 2-4%, and high-carbon ductile cast steel profiles with a carbon content of 1-2% and a silicon content of 1-1.9%; and recycling scrap from the end products into a converter or an electric arc furnace for smelting.

### FIELD OF THE INVENTION

The present invention relates to the field of iron and steel metallurgy, and in particular, to a systematic carbon emissions reduction method for a whole process of steel production and casting process.

### DESCRIPTION OF THE PRIOR ART

To address global climate change, reducing carbon dioxide (CO₂) greenhouse gas emissions and achieving low-carbon production have become the focus of social attention. The iron and steel industry, which is highly energy-intensive, is one of the largest carbon emitters among the 31 categories of the manufacturing industry. In 2022, China's crude steel output reached 1.013 billion tons, the highest in the world, with CO₂ emissions of 2.1 billion tons, accounting for approximately 15-17% of the country's total carbon emissions. The blast furnace-converter process, based on carbon metallurgy and iron ore, accounts for about 90% of the total steel production. Among this process, blast furnace ironmaking is the process with the largest CO₂ emissions, accounting for 70-90% of the total CO₂ emissions in the entire iron and steel production. Using hydrogen to replace carbon as much as possible as a reducing agent and fuel in the ironmaking process—with the product of hydrogen's participation in the reaction being water—can further significantly reduce CO₂ emissions and fundamentally realize low-carbon smelting in blast furnaces. The application of green hydrogen in hydrogen-enriched low-carbon smelting of blast furnaces has become a research hotspot for transformative technologies in the iron and steel manufacturing process. Meanwhile, to further realize the comprehensive and effective utilization of waste heat and energy throughout the entire process based on the traditional long-process of blast furnace-converter, so as to achieve the lowest possible process energy consumption and further achieve energy conservation and carbon reduction, it is also necessary to construct and optimize a new system. In addition, the hydrogen currently used in factories is mainly a by-product obtained from the separation of coke oven gas, while producing hydrogen through water electrolysis requires a large amount of electrical energy. Therefore, it is necessary to introduce stable green energy into the carbon-free iron and steel smelting process to produce sufficient hydrogen to truly achieve the goal of full-process carbon reduction. At the same time, the existing perspective on carbon reduction mainly focuses on the source and process of iron and steel production, while ignoring the carbon sequestration effect of end products.

### SUMMARY OF THE INVENTION

To address the aforementioned problems, the present invention provides a systematic carbon emissions reduction method for whole process of steel production and casting, comprising the steps of: injecting hydrogen into a blast furnace;
wherein the hydrogen is sourced from a nuclear-based hydrogen production system, a water electrolysis hydrogen production system, and a coke oven gas-steam reforming hydrogen production system;
wherein the nuclear-based hydrogen production system comprises a nuclear power generation subsystem, a hydrogen production thermal cycle subsystem, and a hydrogen-enriched blast furnace-converter subsystem;
wherein the nuclear power generation subsystem generates electricity through a high-temperature helium Brayton/Rankine bottoming cycle and delivers steam to the hydrogen production thermal cycle subsystem;
wherein a thermochemical reaction occurs in the nuclear-heated hydrogen production cycle system to produce hydrogen and oxygen; the hydrogen is heated within the nuclear heating cycle system, while the oxygen releases heat within the same system; the high-temperature hydrogen and low-temperature oxygen, after thermal energy conversion, are introduced into the hydrogen-enriched blast furnace-converter subsystem;
wherein electrical energy consumed by the water electrolysis hydrogen production system is sourced from gas-fired power generation, steam residual pressure power generation, solar power generation, wind power generation, and off-peak grid electricity;
wherein combustible gases used for the gas-fired power generation are coke oven gas, blast furnace gas, and converter gas;
wherein steam for the steam residual pressure power generation is sourced from a sintering waste heat boiler;
wherein steam for the coke oven gas-steam reforming hydrogen production is low-pressure steam exhausted from the residual pressure power generation;
producing end products comprising cast steel sections and casting materials including high-carbon ductile cast iron profiles with a carbon content of 2-4% and a silicon content of 2-4%, and high-carbon ductile cast steel profiles with a carbon content of 1-2% and a silicon content of 1-1.9%; and recycling scrap from the end products into a converter or an electric arc furnace for smelting.

Furthermore, the nuclear power generation subsystem comprises a nuclear reactor, a first steam turbine, a first generator, a steam generator, a first compressor, a second steam turbine, a second generator, a condenser, a condensate pump, a low-pressure heater, a deaerator, a feed water pump, and a high-pressure heater;
high-temperature helium output from the nuclear reactor is directed to the first steam turbine and the hydrogen production thermal cycle subsystem; the high-temperature helium expands in the first steam turbine to perform work, driving the first generator to generate electricity; the first steam turbine discharges low-pressure helium to the steam generator;
the low-pressure helium transfers its thermal energy in the steam generator to convert industrial water into steam via a Rankine bottoming cycle, said steam being fed to the second steam turbine; the low-temperature, low-pressure helium is compressed by the first compressor and returned to the nuclear reactor as a reactor coolant for recirculation;
a portion of steam from the second steam turbine is extracted and directed to the hydrogen production thermal cycle subsystem; the remaining steam expands in the second steam turbine to perform work, driving the second generator to generate electricity, and is then discharged into the condenser; the electricity generated by the second generator is supplied to the hydrogen production thermal cycle subsystem;
condensate from the condenser is pressurized by the condensate pump and, combined with industrial wastewater provided by the hydrogen-enriched blast furnace-converter subsystem, passes sequentially through the low-pressure heater, the deaerator, the feed water pump, and the high-pressure heater before entering the tube side of the steam generator, where oxygen and other gases are removed from the water, thereby serving as partial feedwater for the steam Rankine cycle.

Furthermore, the hydrogen production thermal cycle subsystem comprises a first pressure reducing valve, a second pressure reducing valve, an iodine-sulfur cycle hydrogen and oxygen production unit, a gas mixing chamber, a high-temperature low-pressure heater, and a temperature control system;
high-temperature helium output from the nuclear reactor is directed to the second pressure reducing valve, while a portion of steam extracted from the second steam turbine is directed to the first pressure reducing valve; both streams are pressure-reduced to the operating pressure of the iodine-sulfur cycle hydrogen and oxygen production unit; the output high-temperature helium and high-temperature steam jointly provide thermal energy to the iodine-sulfur cycle hydrogen and oxygen production unit, with the high-temperature steam additionally supplementing the steam required for thermochemical reactions in said unit;
the iodine-sulfur cycle hydrogen and oxygen production unit undergoes thermochemical reactions to produce high-temperature hydrogen and oxygen; the produced high-temperature hydrogen enters the gas mixing chamber and combines with coke oven gas and carbon monoxide generated by the hydrogen-enriched blast furnace-converter subsystem to form a high-temperature reducing atmosphere; said atmosphere exchanges heat in the high-temperature low-pressure heater with high-temperature helium that has passed through the second pressure reducing valve and the temperature control system to achieve stable pressure and temperature conditions, before being introduced into the hydrogen-enriched blast furnace-converter subsystem;
the high-temperature oxygen releases heat through the low-pressure heater and the high-pressure heater, and after thermal energy conversion, is introduced into the hydrogen-enriched blast furnace-converter subsystem.

Furthermore, the hydrogen-enriched blast furnace-converter subsystem comprises a hydrogen-enriched blast furnace, a converter, a slag waste heat recovery device, a third generator, and a top gas purification unit; the top gas purification unit comprises a desulfurization tower, a capture tower, a regeneration tower, a dust remover, a top gas dechlorination and desulfurization wastewater treatment device, a second compressor, and a carbon dioxide storage tank;
the produced high-temperature reducing atmosphere facilitates reduction reactions in the hydrogen-enriched blast furnace, producing molten iron which is charged into the converter; low-temperature oxygen is introduced into both the hydrogen-enriched blast furnace and the converter to facilitate oxidation reactions, yielding steel products; simultaneously, waste heat from slag is recovered by the slag waste heat recovery device utilizing a Kalina cycle power generation system to convert thermal energy into electrical energy, enabling the third generator to generate electricity for powering the top gas purification unit and the top gas dechlorination and desulfurization wastewater treatment device;
top gas discharged from the hydrogen-enriched blast furnace passes through the dust remover and then enters the top gas purification unit, where it sequentially flows through the desulfurization tower, the capture tower, and the regeneration tower before the remaining gaseous components are discharged into the atmosphere;
top gas fed into the desulfurization tower of the top gas purification unit produces blast gas washing wastewater, which is directed to the condensate pump for circulation to provide industrial water required by the iodine-sulfur cycle hydrogen and oxygen production unit;
the capture tower captures carbon monoxide and feeds it into the gas mixing chamber to recirculate and supplement the reducing atmosphere;
the regeneration tower extracts carbon dioxide and feeds it into the second compressor and the carbon dioxide storage tank.

Furthermore, carbon dioxide (CO₂) produced from the combustion of coke oven gas, blast furnace gas, and converter gas in the gas-fired power generation process is captured through carbon capture technology and subsequently stored.

Furthermore, electrical energy generated from gas-fired power generation, steam residual pressure power generation, solar power generation, wind power generation, and nuclear power generation is integrated into an internal power grid of the steel plant and transmitted to water electrolysis hydrogen production equipment.

Furthermore, steam generated by the sintering waste heat boiler is fed into a high-pressure steam pipeline and delivered to the residual pressure power generation unit.

Furthermore, low-pressure steam exhausted from the residual pressure power generation unit is conveyed through a low-pressure steam pipeline to the reaction furnace for coke oven gas-steam reforming hydrogen production.

The present invention achieves carbon reduction at the source by injecting hydrogen into the blast furnace to maximally replace fossil fuels, thereby reducing the input of carbon into the steel production process. This hydrogen-for-carbon substitution reduces carbon emissions per unit product by approximately 20% at the source. Simultaneously, by utilizing high-carbon cast iron profiles and ductile cast steel profiles to replace traditional construction steels and machinery steels, the carbon introduced into the steel production process is sequestered within the end products. These high-carbon end products will later be recycled as scrap iron and scrap steel in electric arc furnaces and converter steelmaking, preventing their release as carbon dioxide and thereby achieving an end-product carbon sequestration rate of over 25%. Furthermore, the invention introduces a nuclear-based hydrogen production system aligned with the aforementioned process, which completely eliminates carbon footprints at the source through nuclear-driven hydrogen generation. It also enables comprehensive utilization of waste heat and by-products across the entire steel production process: sintering waste heat is used to generate steam; the steam is simultaneously utilized for reforming hydrogen production and residual pressure power generation; and the steam exhausted from residual pressure power generation is further employed for reforming with coke oven gas to produce hydrogen. This systematically integrates and maximizes the use of various resources within the steel production workflow, thereby achieving systematic carbon reduction throughout the entire source-to-end steelmaking and casting process.

The following description will further elucidate the concept, specific structure, and technical effects of the present invention in conjunction with the accompanying drawings, to fully illustrate the objectives, features, and advantages of the invention.

### BRIEF DESCRIPTION OF THE DRAWINGS

FIG. 1 is a process flow diagram of the systematic carbon reduction method for the entire process of steel and casting production according to the present invention;

FIG. 2 is a process flow diagram of the nuclear hydrogen production system in the method of the present invention.

### DETAILED DESCRIPTION OF THE EMBODIMENTS

A plurality of preferred embodiments of the present invention are described below with reference to the drawings, which makes its technical content more clear and convenient to understand. The present invention may be embodied in many different forms of embodiments, and the scope of protection of the present invention is not limited to the embodiments set forth herein.

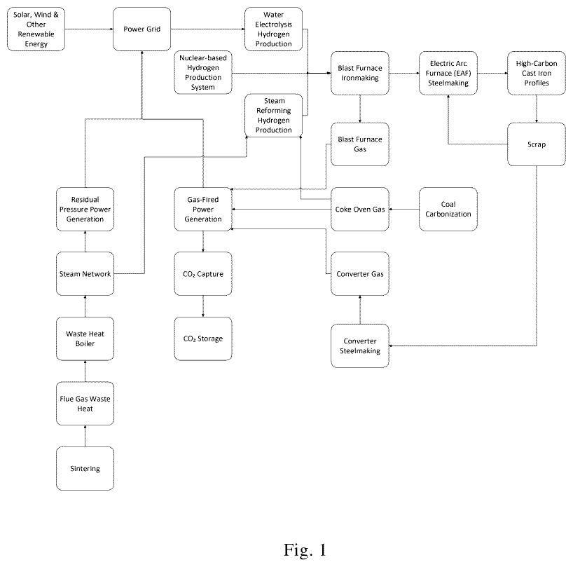

As shown in FIG. 1, the systematic decarbonization method for the entire steel and casting process according to the present invention primarily comprises two components: source carbon reduction and end-product carbon sequestration. Source carbon reduction involves injecting hydrogen into the blast furnace during the ironmaking process, where hydrogen is used to maximally replace carbon as both the reducing agent and fuel. This approach reduces the introduction of carbon into the steel smelting process at the source. End-product carbon sequestration, on the other hand, refers to the production of high-carbon cast iron profiles (carbon content: 2-4%) and ductile cast steel profiles (silicon content: 1-1.9%, carbon content: 1-2%) via electric arc furnace steelmaking. These products serve as end materials, replacing conventional construction steels (carbon content: ~0.2%), thereby sequestering more carbon in the final products. In this way, the goal of low-carbon steel production is achieved through end-product carbon sequestration.

Continuing with reference to FIG. 1, it can be seen that in the method of the present invention, the hydrogen used for blast furnace hydrogen injection primarily originates from two sources: hydrogen production via water electrolysis and hydrogen production through coke oven gas-steam reforming. The electrical energy consumed in water electrolysis for hydrogen production can be sourced from nuclear power generation, gas-fired power generation, steam residual pressure power generation, and off-peak grid electricity. The combustible gases used for gas-fired power generation are respectively coke oven gas from the coking process in steel plant coke ovens, blast furnace gas from the blast furnace ironmaking process, and converter gas from the converter steelmaking process. Among these, the combustible components of coke oven gas are hydrogen (55%~60%) and methane (23%~27%), along with a small amount of carbon monoxide (5%~8%); the combustible component of blast furnace gas is carbon monoxide, accounting for approximately 25%; and the combustible component of converter gas is carbon monoxide, with a content of 60-80%. The CO₂ produced after the combustion of coke oven gas, blast furnace gas, and converter gas can be captured and stored through carbon capture technology. Steam residual pressure power generation utilizes back-pressure units to convert thermal energy into electrical energy by leveraging steam pressure differences. The steam for residual pressure power generation is recovered from high-temperature flue gas in the sintering process using waste heat boilers and is transported to the residual pressure power generation unit via high-pressure steam pipelines for electricity generation. Coke oven gas-steam reforming for hydrogen production involves reacting coke oven gas with steam to generate hydrogen and carbon monoxide, which is then converted and separated to obtain hydrogen. Here, coke oven gas is a by-product of the coking process in steel plants, while the steam can come directly from waste heat boilers or from low-pressure steam after residual pressure power generation. The low-pressure steam is transported to the reaction furnace for coke oven gas-steam reforming via low-pressure steam pipelines. Based on hydrogen production through water electrolysis and coke oven gas-steam reforming, along with hydrogen injection into the blast furnace, the carbon emissions per ton of product can be reduced by 25% from the source.

In practical production, the massive amount of hydrogen required for injection necessitates substantial electrical energy consumption for hydrogen production via water electrolysis. If the electricity for electrolysis still comes from coal-fired power generation, truly green metallurgy cannot be achieved.

Therefore, in a further embodiment of the present invention, a nuclear-based hydrogen production system is provided. The system comprises a nuclear power generation subsystem, a hydrogen production thermal cycle subsystem, and a hydrogen-enriched blast furnace-converter subsystem. The nuclear power generation subsystem employs a high-temperature helium Brayton/Rankine bottoming cycle for power generation and delivers steam to the hydrogen production thermal cycle subsystem. Within the nuclear-heated hydrogen production cycle system, a thermochemical reaction occurs to produce hydrogen and oxygen. The hydrogen is heated utilizing both thermal and electrical energy in the nuclear heating cycle system, while the oxygen releases waste heat. After thermal energy conversion, the high-temperature hydrogen and low-temperature oxygen are introduced into the hydrogen-enriched blast furnace-converter subsystem, where they are utilized to create a reducing oxidative atmosphere.

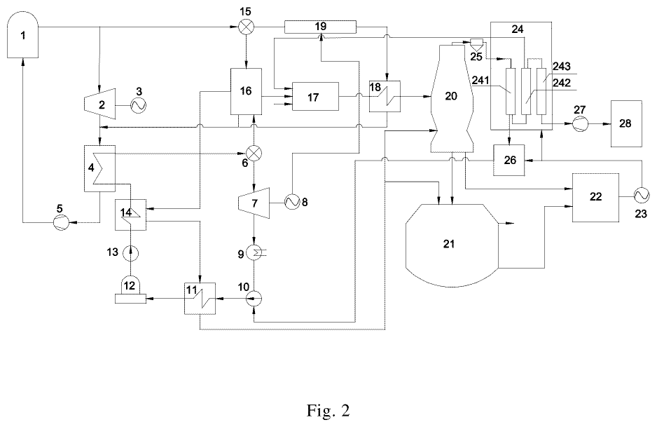

As shown in FIG. 2, the nuclear power generation subsystem comprises a nuclear reactor (1), a first steam turbine (2), a first generator (3), a steam generator (4), a first compressor (5), a second steam turbine (7), a second generator (8), a condenser (9), a condensate pump (10), a low-pressure heater (11), a deaerator (12), a feed water pump (13), and a high-pressure heater (14).

The hydrogen production thermal cycle subsystem includes a first pressure reducing valve (6), a second pressure reducing valve (15), an iodine-sulfur cycle hydrogen and oxygen production unit (16), a gas mixing chamber (17), a high-temperature low-pressure heater (18), and a temperature control system (19).

The nuclear reactor (1) discharges high-temperature helium at 900-1000° C. and 7-8 MPa. The high-temperature helium pipelines are constructed from Al-containing 310S austenitic stainless steel. The helium is then directed into the first steam turbine (2) of the nuclear power generation subsystem and the second pressure reducing valve (15) of the hydrogen production thermal cycle subsystem.

A portion of the high-temperature helium gas entering the nuclear power generation subsystem expands in the first steam turbine (2) to perform work, driving the first generator (3) to generate electricity. The first steam turbine (2) discharges low-pressure helium to the steam generator (4). The temperature of the low-pressure helium-formed by mixing the output from the first steam turbine (2) and the recirculated low-pressure helium from the hydrogen production thermal cycle subsystem-ranges from 600° C. to 700° C. In the steam generator (4), the thermal energy of the low-pressure helium is transferred via a Rankine bottoming cycle to convert industrial water into steam, which is then fed to the second steam turbine (7). Simultaneously, low-temperature, low-pressure helium at 300° C. to 400° C. is exhausted to the first compressor (5). The first compressor (5) compresses this helium and delivers it back to the nuclear reactor (1) at a temperature of 350° C. to 450° C.

The industrial water, after being heated by the low-pressure helium, is converted into steam in the steam generator (4). A portion of this steam is extracted from the second steam turbine (7) and directed to the first pressure reducing valve (6) of the hydrogen production thermal cycle subsystem. After pressure reduction, the steam is supplied to the iodine-sulfur cycle hydrogen and oxygen production unit (16). The remaining steam expands in the second steam turbine (7) to drive the second generator (8) for power generation, and is then discharged into the condenser (9). The electricity generated by the second generator (8) is supplied to the temperature control system (19) of the hydrogen production thermal cycle subsystem. The condensate output from the condenser (9) is pressurized by the condensate pump (10) and, in combination with industrial wastewater supplied by the hydrogen-enriched blast furnace-converter subsystem, passes sequentially through the low-pressure heater (11), deaerator (12), feed water pump (13), and high-pressure heater (14). The resulting feedwater then enters the tube side of the steam generator (4) to form the feedwater for the Rankine cycle.

The nuclear reactor (1) discharges the remaining high-temperature helium to the second pressure reducing valve (15) for pressure reduction. Said reduced-pressure helium, together with the steam depressurized by the first pressure reducing valve (6), provides the necessary thermal energy to the iodine-sulfur cycle hydrogen and oxygen production unit (16), which operates at a working temperature of 800-900° C. and a working pressure of 4-5 MPa. The high-temperature steam simultaneously serves to supplement the water required for the thermochemical reaction in said iodine-sulfur cycle hydrogen and oxygen production unit (16). Within said unit (16), a thermochemical reaction occurs to produce high-temperature hydrogen and oxygen, comprising the steps of:
Bunsen reaction (20-120° C.):

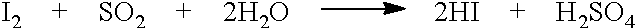

Hydroiodic acid decomposition reaction (400-500° C.):

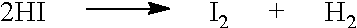

Sulfuric acid decomposition reaction (800-900° C.):

$${H}_{2} {SO}_{4} \to {SO}_{2} + {H}_{2} O + \frac{1}{2} {O}_{2}$$

Considering the high-temperature conditions and acid corrosion issues, the iodine-sulfur cycle hydrogen and oxygen production unit (16) and its associated pipelines are constructed from Al-containing 310S austenitic stainless steel. The high-temperature hydrogen gas produced enters the gas mixing chamber (17), where it combines with coke oven gas and carbon monoxide from the top gas purification unit (24) of the hydrogen-enriched blast furnace-converter subsystem to form a high-temperature reducing atmosphere. This atmosphere is then heated to 950-1050° C. in a high-temperature low-pressure heater (18) made of GH3536 nickel-based alloy, through thermal energy exchange with high-temperature helium (at 1000-1100° C.) that has passed through the second pressure reducing valve (15) and been electrically heated by the temperature control system (19). The heated reducing atmosphere is subsequently introduced into the hydrogen-enriched blast furnace-converter subsystem. After transferring thermal energy, the temperature of the helium drops to 750-850° C. This cooled helium merges with the low-temperature helium (at 300-500° C.) that has experienced thermal loss in the iodine-sulfur cycle hydrogen and oxygen production unit (16), ultimately forming helium at 600-700° C. for recirculation into the nuclear power generation subsystem. Meanwhile, the high-temperature oxygen releases heat through the low-pressure heater (11) and the high-pressure heater (14). After this thermal energy conversion, the oxygen is introduced into the hydrogen-enriched blast furnace-converter subsystem for recycling.

The hydrogen-enriched r subsystem comprises: a hydrogen-enriched blast furnace (20), a converter (21), a waste heat recovery device for slag (22), a third generator (23), a top gas purification unit (24), a dust remover (25), a wastewater treatment device for top gas dechlorination and desulfurization (26), a second compressor (27), and a carbon dioxide storage tank (28).

The high-temperature reducing atmosphere produced by the hydrogen production thermal cycle subsystem is injected through the lower shaft or bosh region of the hydrogen-enriched blast furnace (20). The gas pipelines and the gas flow distribution device within the furnace are constructed of GH3536 nickel-based alloy. Reduction reactions occur in the hydrogen-enriched blast furnace (20), producing molten iron that is charged into the converter (21). The low-temperature oxygen is introduced into both the hydrogen-enriched blast furnace (20) and the converter (21) to facilitate oxidation reactions. While producing steel products, waste heat from the slag is recovered by the slag waste heat recovery device (22). Utilizing a Kalina cycle power generation system, thermal energy is converted into electrical energy, enabling the third generator (23) to generate electricity. The power generated is supplied to operate the top gas purification unit (24) and the wastewater treatment device for top gas dechlorination and desulfurization (26).

The top gas generated from the reduction and oxidation reactions in the hydrogen-enriched blast furnace (20) passes sequentially through the dust remover (25) and the top gas purification unit (24), after which the remaining harmless gaseous components are discharged into the atmosphere.

The top gas purification unit (24) comprises a desulfurization tower (241), a capture tower (242), and a regeneration tower (243). The desulfurization tower (241) is in communication with the capture tower (242), the dust remover (25), and the wastewater treatment device for top gas dechlorination and desulfurization (26). The wastewater treatment device for top gas dechlorination and desulfurization (26) is in communication with the condensate pump (10). The capture tower (242) is in communication with the regeneration tower (243) and the gas mixing chamber (17). The regeneration tower (243) is in communication with the second compressor (27).

The top gas, after passing through the dust remover (25), enters the desulfurization tower (241) where toxic components including hydrogen chloride, carbonyl sulfide, and hydrogen sulfide are removed. The resulting top gas washing wastewater is treated by the wastewater treatment device for top gas dechlorination and desulfurization (26) and then enters the condensate pump (10), where it is utilized as industrial water for the Rankine cycle, thereby achieving circular utilization. The preliminarily purified top gas subsequently passes through the capture tower (242) where carbon monoxide is captured and conveyed to the gas mixing chamber (17) for recirculation, regulating and supplementing the reducing atmosphere. Finally, the further purified top gas enters the regeneration tower (243) where carbon dioxide is extracted. The captured carbon dioxide is fed into the second compressor (27) for compression and stored in the carbon dioxide storage tank (28) for utilization in other industries. The ultimately purified, harmless top gas is then discharged.

The present invention achieves source carbon reduction by injecting hydrogen into the blast furnace to maximally replace fossil fuels, thereby reducing the input of carbon into the steel production process from the origin. This hydrogen-for-carbon substitution reduces the carbon emission per unit product by approximately 20% at the source. Simultaneously, by utilizing high-carbon cast iron profiles and ductile cast steel profiles to replace traditional construction steels and machinery steels, the carbon introduced into the steel production process is sequestered within the end products. These high-carbon end products will later be recycled as scrap iron and scrap steel in electric arc furnaces and converter steelmaking, preventing their release as carbon dioxide and thereby achieving an end-product carbon sequestration rate of over 25% per ton of product. Furthermore, the invention introduces a nuclear-based hydrogen production system aligned with the aforementioned process. This system completely eliminates carbon footprints at the source through nuclear-driven hydrogen generation and enables comprehensive utilization of waste heat and by-products across the entire steel production process. For instance, sintering waste heat is recovered to generate steam; this steam is simultaneously utilized for reforming hydrogen production and residual pressure power generation; subsequently, the steam exhausted from residual power generation is further employed for reforming with coke oven gas to produce hydrogen. This approach systematically integrates and maximizes the use of various resources within the steel production workflow. Additionally, the invention proposes the use of nuclear energy as the primary green energy source for hydrogen production via water electrolysis and specifically provides a dedicated nuclear-based hydrogen production system. This integrated solution achieves systematic carbon reduction throughout the entire steelmaking and casting process.

The foregoing has provided a detailed description of preferred specific embodiments of the present invention. It should be understood that those of ordinary skill in the art, without creative effort, could make numerous modifications and variations based on the concept of the present invention. Therefore, any technical solutions that can be obtained by a person skilled in the art through logical analysis, reasoning, or limited experimentation on the basis of existing technology, in accordance with the inventive concept, shall fall within the scope of protection defined by the claims.

1. A systematic carbon emissions reduction method for whole process of steel production and casting, characterized by comprising the steps of:
blast furnace hydrogen injection; wherein the hydrogen is sourced from a nuclear-based hydrogen production system, a water electrolysis hydrogen production system, and a coke oven gas-steam reforming hydrogen production system; wherein,
the nuclear-based hydrogen production system comprises a nuclear power generation subsystem, a hydrogen production thermal cycle subsystem, and a hydrogen-enriched blast furnace-converter subsystem; wherein,
the nuclear power generation subsystem comprises a nuclear reactor (1), a first steam turbine (2), a first generator (3), a steam generator (4), a first compressor (5), a second steam turbine (7), a second generator (8), a condenser (9), a condensate pump (10), a low-pressure heater (11), a deaerator (12), a feed water pump (13), and a high-pressure heater (14);
the hydrogen production thermal cycle subsystem comprises a first pressure reducing valve (6), a second pressure reducing valve (15), an iodine-sulfur cycle hydrogen and oxygen production unit (16), a gas mixing chamber (17), a high-temperature low-pressure heater (18), and a temperature control system (19);
the hydrogen-enriched blast furnace-converter subsystem comprises a hydrogen-enriched blast furnace (20), a converter (21), a slag waste heat recovery device (22), a third generator (23), a top gas purification unit (24), a dust remover (25), a top gas dechlorination and desulfurization wastewater treatment device (26), a second compressor (27), and a carbon dioxide storage tank (28); wherein,
the nuclear reactor (1) outputs high-temperature helium at 900-1000° C. and 7-8 MPa, which is directed to the first steam turbine (2) of the nuclear power generation subsystem and to the second pressure reducing valve (15) of the hydrogen production thermal cycle subsystem;
the high-temperature helium expands in the first steam turbine (2) to perform work, driving the first generator (3) to generate electricity, which is supplied to the water electrolysis hydrogen production system;
the low-pressure helium output from the first steam turbine (2) mixes with recirculated low-pressure helium from the hydrogen production thermal cycle subsystem to form a stream at 600-700° C., which is conveyed to the steam generator (4);
the low-pressure helium transfers its thermal energy in the steam generator (4) to convert industrial water into steam via a Rankine bottoming cycle, said steam being fed to the second steam turbine (7); the helium is then exhausted as low-temperature, low-pressure helium at 300-400° C. to the first compressor (5); said helium is compressed in the first compressor (5) and returned to the nuclear reactor (1) at 350-450° C.;
a portion of the steam generated by the steam generator (4) is directed to the first pressure reducing valve (6) of the hydrogen production thermal cycle subsystem and, after pressure reduction, to the iodine-sulfur cycle hydrogen and oxygen production unit (16);
the remainder of the steam expands in the second steam turbine (7) to perform work, driving the second generator (8) to generate electricity, and is then discharged into the condenser (9); the electricity generated by the second generator (8) is supplied to the temperature control system (19) of the hydrogen production thermal cycle subsystem;
the condensate from the condenser (9) is pressurized by the condensate pump (10) and, combined with industrial wastewater provided by the hydrogen-enriched blast furnace-converter subsystem, passes sequentially through the low-pressure heater (11), the deaerator (12), the feed water pump (13), and the high-pressure heater (14) before entering the tube side of the steam generator (4) as feedwater for the Rankine cycle;
the high-temperature helium from the nuclear reactor (1), after being fed to the second pressure reducing valve (15) and pressure-reduced, is input to the iodine-sulfur cycle hydrogen and oxygen production unit (16); together with the steam from the first pressure reducing valve (6) (after pressure reduction), it provides the necessary thermal energy for the iodine-sulfur cycle hydrogen and oxygen production unit (16) operating at 800-900° C. and 4-5 MPa, wherein the steam also serves to supplement the water required for the thermochemical reaction in said unit (16);
the high-temperature hydrogen produced by the iodine-sulfur cycle hydrogen and oxygen production unit (16) enters the gas mixing chamber (17) and mixes with coke oven gas and carbon monoxide from the top gas purification unit (24) of the hydrogen-enriched blast furnace-converter subsystem to form a high-temperature reducing atmosphere;
said atmosphere enters the high-temperature low-pressure heater (18) and is heated to 950-1050° C. through heat exchange with 1000-1100° C. helium that has passed through the second pressure reducing valve (15) and been electrically heated by the temperature control system (19);
the heated reducing atmosphere is then introduced into the hydrogen-enriched blast furnace-converter subsystem;
after transferring thermal energy, the temperature of the helium drops to 750-850° C.; this cooled helium merges with 300-500° C. low-temperature helium that has experienced thermal loss in the iodine-sulfur cycle hydrogen and oxygen production unit (16), ultimately forming 600-700° C. helium which is recirculated into the nuclear power generation subsystem by mixing with the low-pressure helium output from the first steam turbine (2) and entering the steam generator (4);
the high-temperature oxygen produced by the iodine-sulfur cycle hydrogen and oxygen production unit (16) releases heat through the high-pressure heater (14) and the low-pressure heater (11), undergoes thermal energy exchange with the feedwater entering the steam generator (4), and is then introduced into the hydrogen-enriched blast furnace-converter subsystem;
the high-temperature reducing atmosphere produced by the hydrogen production thermal cycle subsystem is injected into the hydrogen-enriched blast furnace (20) through the lower shaft or bosh region;
reduction reactions occur in the hydrogen-enriched blast furnace (20), producing molten iron which is charged into the converter (21);
low-temperature oxygen is introduced into the hydrogen-enriched blast furnace (20) and the converter (21) to facilitate oxidation reactions, yielding steel products;
simultaneously, waste heat from slag is recovered by the slag waste heat recovery device (22); utilizing a Kalina cycle power generation system, thermal energy is converted into electrical energy, enabling the third generator (23) to generate electricity to power the top gas purification unit (24) and the top gas dechlorination and desulfurization wastewater treatment device (26);
the top gas generated from the reduction and oxidation reactions in the hydrogen-enriched blast furnace (20) passes sequentially through the dust remover (25) and the top gas purification unit (24), after which the remaining harmless gaseous components are discharged into the atmosphere;
the top gas, after passing through the dust remover (25), is treated through the desulfurization tower (241) of the top gas purification unit (24); the resulting top gas washing wastewater is treated by the top gas dechlorination and desulfurization wastewater treatment device (26) and then fed to the condensate pump (10) for reuse as industrial water in the Rankine cycle, achieving circular utilization;
the electrical energy consumed by the water electrolysis hydrogen production system is additionally sourced from gas-fired power generation, steam residual pressure power generation, solar power generation, wind power generation, and off-peak grid electricity; the combustible gases used for gas-fired power generation are coke oven gas, blast furnace gas, and converter gas; the steam for steam residual pressure power generation is sourced from sintering waste heat boilers;
the steam for the coke oven gas-steam reforming hydrogen production is low-pressure steam obtained after residual pressure power generation;
the end products are cast steel sections and casting materials comprising high-carbon ductile cast iron profiles with a carbon content of 2-4% and a silicon content of 2-4%, and high-carbon ductile cast steel profiles with a carbon content of 1-2% and a silicon content of 1-1.9%;
scrap from the end products is introduced into the converter or electric arc furnaces for recycling and smelting.

2. The method of claim 1, wherein the top gas purification unit (24) comprises: a desulfurization tower (241), a capture tower (242), and a regeneration tower (243); wherein: the desulfurization tower (241) is in fluid communication with the capture tower (242), the dust remover (25), and the wastewater treatment device for top gas dechlorination and desulfurization (26); the wastewater treatment device for top gas dechlorination and desulfurization (26) is in fluid communication with the condensate pump (10); the capture tower (242) is in fluid communication with the regeneration tower (243) and the gas mixing chamber (17); and the regeneration tower (243) is in fluid communication with the second compressor (27).

3. The method of claim 2, wherein the top gas is further processed through the regeneration tower (243) to extract carbon dioxide; the extracted carbon dioxide is fed into the second compressor (27) for compression and subsequently stored in the carbon dioxide storage tank (28).

4. The method of claim 1, wherein electrical energy generated from the gas-fired power generation, steam residual pressure power generation, solar power generation, and wind power generation is integrated into an internal power grid of the steel plant and transmitted to the water electrolysis hydrogen production equipment.

5. The method of claim 1, wherein steam generated by a sintering waste heat boiler is integrated into a high-pressure steam pipeline and transmitted to a residual pressure power generation unit.

6. The method of claim 1, wherein low-pressure steam exhausted from the residual pressure power generation unit is conveyed through a low-pressure steam pipeline to a reaction furnace for coke oven gas-steam reforming hydrogen production.
